(19) United States
(12) Patent Application Publication
(10) Pub. No.: US 2015/0296474 A1
(43) Pub. Date: Oct. 15, 2015

(54) Method and System for Positioning Mobile Terminal in LTE System

(71) Applicant: ZTE CORPORATION, Shenzhen (CN)

(72) Inventors: Wanjie Cai, Shenzhen (CN); Jianhong Xie, Shenzhen (CN)

(21) Appl. No.: 14/439,140

(22) PCT Filed: Sep. 18, 2013
(86) PCT No.: PCT/CN2013/083805

§ 371 Date: Apr. 28, 2015

(30) Foreign Application Priority Data
Nov. 7, 2012 (CN) 201210441001.0

(51) Int. Cl. H04W 64/00; H04W 24/10

(52) U.S. Cl. CPC H04W 64/00; H04W 24/10

(57) ABSTRACT

Provided is a method for positioning a mobile terminal in an LTE system, wherein the method comprises: a serving cell/base station sends respectively resource reservation notification messages to multiple neighbouring cells/base stations thereof, to notify the neighbouring cells/base stations to reserve measurement resources for SRS measurement of a mobile terminal; the mobile terminal sends SRSs to the serving cell/base station and the neighbouring cells/base stations by using the measurement resources respectively, so that the serving cell/base station and the neighbouring cells/base stations perform SRS measurement; and the serving cell/base station positions the mobile terminal according to results of the SRS measurement. Also provided is a corresponding system.

### TECHNICAL FIELD

The disclosure relates to the field of wireless communications, and in particular to a method and system for positioning a mobile terminal in an LTE system.

### BACKGROUND

With the development of the mobile communication technology, services of a mobile communication system are more and more diverse; a positioning service is an important service in a wireless communication system, and at present, three positioning technologies are mainly used in the third generation wireless communication system (3G): Assisted Global Positioning System (A-GPS), Observed Time Difference of Arrival (OTDOA) and CEllId+RTT.

The A-GPS requires a wireless terminal to be built-in a GPS receiver, and to cooperate a network to complete positioning, and the positioning accuracy is high, but the wireless terminal is required to be able to face three satellites at the same time; the OTDOA completes positioning by measuring distances between the wireless terminal and three NodeBs respectively and using a method of hyperbola positioning, but the method requires the wireless terminal to be able to support OTDOA measurement; the CellId+RTT is an enhancement method of CellId positioning, and completes the positioning on the wireless terminal by determining a distance between a cell where the wireless terminal is located and a NodeB antenna, and the positioning accuracy of the CellId is totally up to the size of the cell, and the positioning accuracy is larger than 500 m, which still cannot satisfy the requirements of most users; however, CellId+RTT makes amendments on this basis, and although the positioning accuracy is improved to a certain extent, the effect is not obvious.

### SUMMARY

The embodiments of the disclosure are intended to provide a method and system for positioning a mobile terminal in an LTE system, which may perform accurate positioning on the mobile terminal without adding any device and without coordination of the network side.

The embodiments of the disclosure provide a method for positioning a mobile terminal in an LTE system, wherein the method comprises:

a serving cell/NodeB respectively sending resource reservation notification messages to multiple neighbouring cells/NodeBs adjacent thereto, to notify the multiple neighbouring cells/NodeBs to reserve measurement resources which are for a mobile terminal to perform Sounding Reference Signal (SRS) measurement;

the mobile terminal respectively sending SRSs to the serving cell/NodeB and the neighbouring cells/NodeBs by using the measurement resources, so that the serving cell/NodeB and the neighbouring cells/NodeBs to measure the SRSs; and

the serving cell/NodeB positioning the mobile terminal according to results that the serving cell/NodeB and the neighbouring cells/NodeBs respectively measure the SRSs.

Preferably, each of the results that the serving cell/NodeB and the neighbouring cells/NodeBs respectively measure the SRSs comprises a received signal strength indicator and a timing advance.

Preferably, before the serving cell/NodeB respectively sends the resource reservation notification messages to the multiple neighbouring cells/NodeBs adjacent thereto, the method further comprises:

the serving cell/NodeB judging whether there is pre-stored information about the multiple pre-stored neighbouring cells/NodeBs adjacent thereto; if not, then notifying the mobile terminal to measure information about the multiple neighbouring cells/NodeBs adjacent to the serving cell/NodeB, or initiating a paging message to the mobile terminal so as to acquire information about the multiple neighbouring cells/NodeBs.

Preferably, the serving cell/NodeB positioning the mobile terminal according to the results that the serving cell/NodeB and the neighbouring cells/NodeBs respectively measure the SRSs comprises:

the serving cell/NodeB summarizing the results that the serving cell/NodeB and the neighbouring cells/NodeBs respectively measure the SRSs;

calculating a distance between the mobile terminal and the serving cell/NodeB and each distance between the mobile terminal and each of the neighbouring cells/NodeBs through the timing advance; and according to each pre-stored distance between the serving cell/NodeB and each of the neighbouring cells/NodeBs, respectively calculating each angle between the serving cell/NodeB and each of the neighbouring cells/NodeBs; and

according to the distance between the mobile terminal and the serving cell/NodeB, each distance between the mobile terminal and each of the multiple neighbouring cells/NodeBs, and each angle between the serving cell/NodeB and each of the neighbouring cells/NodeBs, positioning the mobile terminal.

The embodiments of the disclosure further provide a system for positioning a mobile terminal in an LTE system, wherein the system comprises a mobile terminal, a serving cell/NodeB and multiple neighbouring cells/NodeBs adjacent to the serving cell/NodeB, wherein

the serving cell/NodeB is configured to respectively send resource reservation notification messages to the multiple neighbouring cells/NodeBs adjacent thereto, to notify the multiple neighbouring cells/NodeBs to reserve measurement resources which are for a mobile terminal to perform SRS measurement; to measure an SRS according to the SRS sent by the mobile terminal; and to position the mobile terminal according to results that the serving cell/NodeB and the multiple neighbouring cells/NodeBs measure SRSs;

the mobile terminal is configured to respectively send the SRS to the serving cell/NodeB and neighbouring cells/NodeBs through the measurement resources; and

the neighbouring cells/NodeBs is configured to measure the SRSs according to the SRSs sent by the mobile terminal.

Preferably, each of the results that the serving cell/NodeB and neighbouring cells/NodeBs measure the SRSs comprises a received signal strength indicator and a timing advance.

Preferably, the serving cell/NodeB is further configured to:

judge whether there is pre-stored information about the multiple neighbouring cells/NodeBs adjacent thereto; if not, then notify the mobile terminal to measure information about the multiple neighbouring cells/NodeBs adjacent to the serving cell/NodeB, or initiate a paging message to the mobile terminal so as to acquire information about the multiple neighbouring cells/NodeBs.

Preferably, the serving cell/NodeB comprises:

a summarizing component configured to summarize the results that the serving cell/NodeB and the multiple neighbouring cells/NodeBs respectively measure the SRSs;

a first calculation component configured to acquire a distance between the mobile terminal and the serving cell/NodeB and each distance between the mobile terminal and the neighbouring cells/NodeBs through the timing advance;

a second calculation component configured to respectively calculate each angle between the serving cell/NodeB and each of the multiple neighbouring cells/NodeBs according to each pre-stored distance between a serving cell/NodeB and each of the multiple neighbouring cells/NodeBs; and

a positioning component configured to, according to the distance between the mobile terminal and the serving cell/NodeB, each distance between the mobile terminal and each of the multiple neighbouring cells/NodeBs, and each angle between the serving cell/NodeB and the neighbouring cells/NodeBs, position the mobile terminal

In the embodiments of the disclosure, a serving cell/NodeB respectively sends resource reservation notification messages to notify the neighbouring cells/NodeBs to reserve measurement resources which are for a mobile terminal to perform SRS measurement, and meanwhile sends a sending notification message to the mobile terminal for notifying the mobile terminal to send SRSs; then the mobile terminal respectively send the SRSs to the serving cell/NodeB and neighbouring cells/NodeBs through measurement resources, so that the serving cell/NodeB and the neighbouring cells/NodeBs respectively measure SRS; and the serving cell/NodeB positions the mobile terminal according to results that the serving cell/NodeB and the neighbouring cells/NodeBs respectively measure the SRSs. By means of the method, the mobile terminal may be accurately positioned without adding any device, without coordination of the network side, and without any additional network device, and the mobile terminal does not need to meet any extra functional requirement.

### BRIEF DESCRIPTION OF THE DRAWINGS

FIG. 1 shows a schematic flow chart of a method for positioning a mobile terminal in an LTE system according to an embodiment of the disclosure;

FIG. 2 shows a schematic flow chart of a method for positioning a mobile terminal in an LTE system according to another embodiment of the disclosure;

FIG. 3 shows a schematic flow chart for positioning a mobile terminal in a method for positioning a mobile terminal in an LTE system according to an embodiment of the disclosure;

FIG. 4 shows a structural schematic diagram of a system for positioning a mobile terminal in an LTE system according to an embodiment of the disclosure; and

FIG. 5 shows a structural schematic diagram of a serving cell/NodeB in a system for positioning a mobile terminal in an LTE system according to an embodiment of the disclosure.

Implementation, functional features and advantages related to the embodiments of the disclosure will be illustrated in the subsequent descriptions and appended drawings.

### DETAIL DESCRIPTION OF EMBODIMENTS

It should be understood that specific embodiments described here are only used for illustrating the disclosure and not intended to limit the disclosure.

The embodiments of the disclosure provide a method for positioning a mobile terminal in an LTE system, without adding any device, without coordination of the network side, and the mobile terminal does not need to meet any extra functional requirement. In the method, the mobile terminal is accurately positioned by performing SRS measurement on a cell/NodeB and according to results of the SRS measurement.

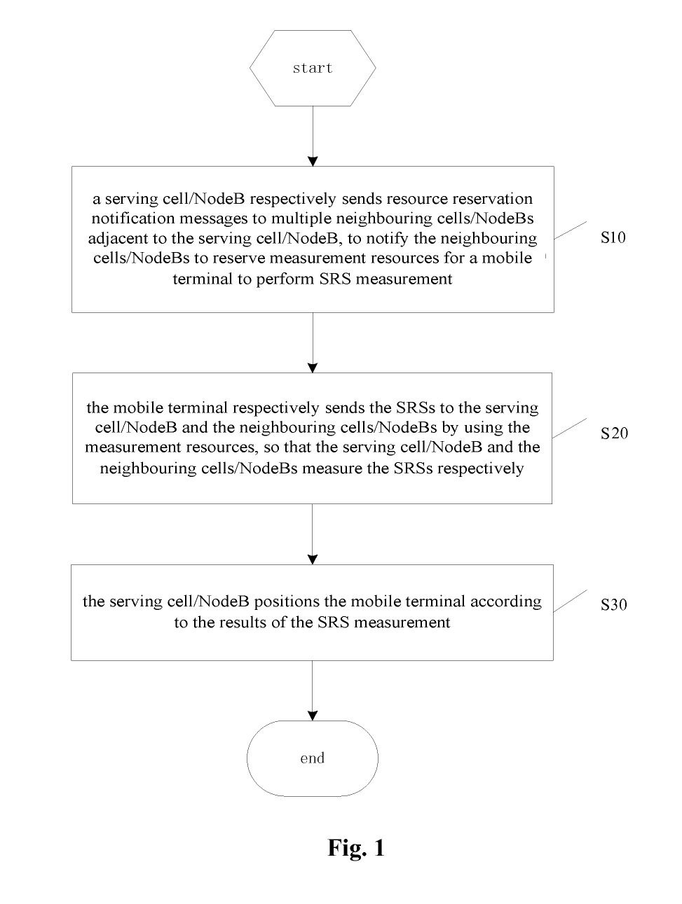

With reference to FIG. 1, FIG. 1 is a schematic flow chart of a method for positioning a mobile terminal in an LTE system according to an embodiment of the disclosure.

The embodiment of the disclosure provides a method for positioning a mobile terminal in an LTE system, wherein the method comprises the following steps.

Step S10, a serving cell/NodeB respectively sends resource reservation notification messages to multiple neighbouring cells/NodeBs adjacent to the serving cell/NodeB, to notify the neighbouring cells/NodeBs to reserve measurement resources for a mobile terminal to perform SRS measurement;

when the mobile terminal is to be positioned, firstly the serving cell/NodeB to which the mobile terminal belongs is determined, and multiple neighbouring cells/NodeBs adjacent to the serving cell/NodeB are determined, and the resource reservation notification messages are respectively sent to multiple neighbouring cells/NodeBs by the serving cell/NodeB, wherein the resource reservation notification messages are used for notifying the neighbouring cells/NodeBs to reserve measurement resources for the mobile terminal to perform the SRS measurement so that the neighbouring cells/NodeBs may receive the SRSs sent by the mobile terminal on the reserved measurement resources. While the serving cell/NodeB sends the resource reservation notification messages to the multiple neighbouring cells/NodeBs, a sending notification message for notifying the mobile terminal to send the SRS is sent to the mobile terminal.

Step S20, the mobile terminal respectively sends the SRSs to the serving cell/NodeB and the neighbouring cells/NodeBs by using the measurement resources, so that the serving cell/NodeB and the neighbouring cells/NodeBs measure the SRSs respectively; and

after receiving the sending notification messages sent from the serving cell/NodeB, the mobile terminal begins to respectively send the SRSs to the serving cell/NodeB and neighbouring cells/NodeBs. After receiving the SRSs, the serving cell/NodeB and neighbouring cells/NodeBs perform SRS measurement according to the SRSs; after the measurement ends, the neighbouring cells/NodeBs will transfer results of the SRS measurement to the serving cell/NodeB; and in the present embodiment, each of the results of SRS measurement comprises a received signal strength indicator and a timing advance.

Step S30, the serving cell/NodeB positions the mobile terminal according to the results of the SRS measurement.

After the serving cell/NodeB and neighbouring cells/NodeBs respectively complete the SRS measurement, the serving cell/NodeB positions the mobile terminal according to the results of the SRS measurement obtained after the measurement, i.e. according to the received signal strength indicator and the timing advance.

In the embodiment of the disclosure, a serving cell/NodeB sends resource reservation notification messages to notify the neighbouring cells/NodeBs to reserve measurement resources for the SRS measurement of the mobile terminal, and meanwhile sends a sending notification message to the mobile terminal for notifying the mobile terminal to send the SRSs; then the mobile terminal sends the SRSs to the serving cell/NodeB and neighbouring cells/NodeBs through measurement resources respectively, so that the serving cell/NodeB and the neighbouring cells/NodeBs perform the SRS measurement; and the serving cell/NodeB positions the mobile terminal according to results of the SRS measurement. By means of the method, the mobile terminal may be accurately positioned without adding any device, without coordination of the network side, and without any additional network device, and the mobile terminal does not need to meet any extra functional requirement.

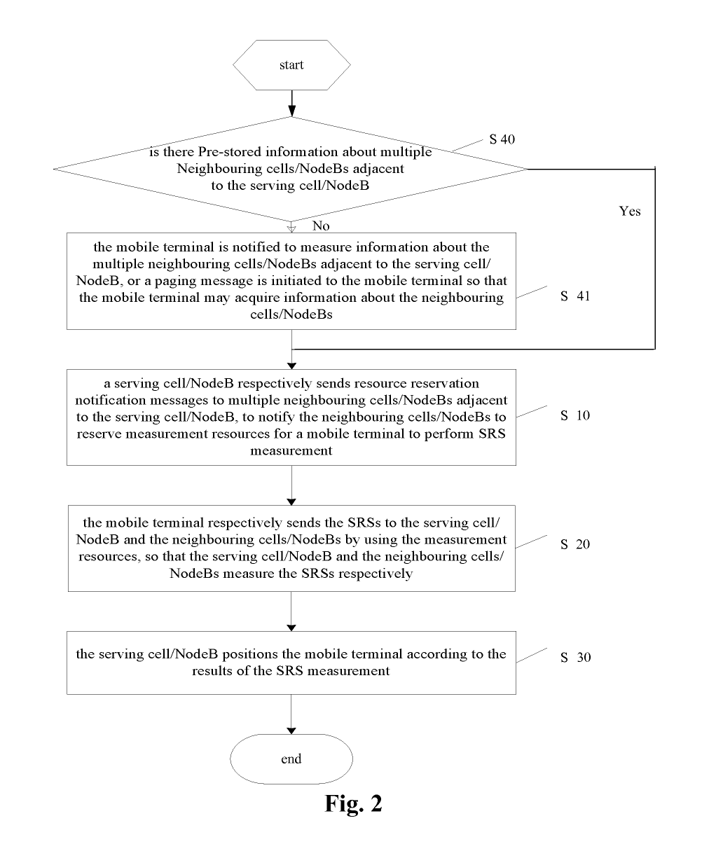

With reference to FIG. 2, FIG. 2 is a schematic flow chart of a method for positioning a mobile terminal in an LTE system according to another embodiment of the disclosure.

Based on the above-mentioned embodiment, before executing step S10, the method for positioning the mobile terminal in an LTE system according to the embodiment of the disclosure further comprises: step S40, the serving cell/NodeB judges whether there is pre-stored information about multiple neighbouring cells/NodeBs adjacent to the serving cell/NodeB; if not, perform step S41;

step S41, the mobile terminal is notified to measure information about the multiple neighbouring cells/NodeBs adjacent to the serving cell/NodeB, or a paging message is initiated to the mobile terminal so that the mobile terminal may acquire information about the neighbouring cells/NodeBs.

When a serving cell/NodeB to which the mobile terminal belongs is determined, the serving cell/NodeB judges whether there is pre-stored information about multiple neighbouring cells/NodeBs adjacent to the serving cell/NodeB, wherein the pre-stored information comprises each distance between each of the neighbouring cells/NodeBs and the serving cell/NodeB as well as signal strength of the neighbouring cells/NodeBs. If no, then the serving cell/NodeB may notify the mobile terminal to measure the neighbouring cells/NodeBs, i.e. by measuring each distance between the serving cell/NodeB and each of the neighbouring cells/NodeBs adjacent thereto as well as the signal strength of the neighbouring cells/NodeBs, and the serving cell/NodeB generates a list of neighbouring cells/NodeBs according to the strength of the signals which is obtained from the measured result, and reports the list to the serving cell/NodeB; the serving cell/NodeB also may acquire information about the neighbouring cells/NodeBs adjacent thereto by initiating a paging message to the mobile terminal, and the paging message initiated by the serving cell/NodeB may be transmitted through an uplink channel. After acquiring the information about the neighbouring cells/NodeBs, the serving cell/NodeB stores same so as to select the neighbouring cells/NodeBs according to each distances between the serving cell/NodeB and each of the neighbouring cells/NodeBs as well as the signal strength of the neighbouring cells/NodeBs.

The serving cell/NodeB judges whether there is pre-stored information about multiple neighbouring cells/NodeBs adjacent to the serving cell/NodeB, and notifies the mobile terminal to measure information about the neighbouring cells/NodeBs adjacent to the serving cell/NodeB, or initiates a paging message to the mobile terminal so as to acquire information about the neighbouring cells/NodeBs, and store information about the acquired neighbouring cells/NodeBs. The above solution may facilitate to position the mobile terminal according to information about the neighbouring cells/NodeBs.

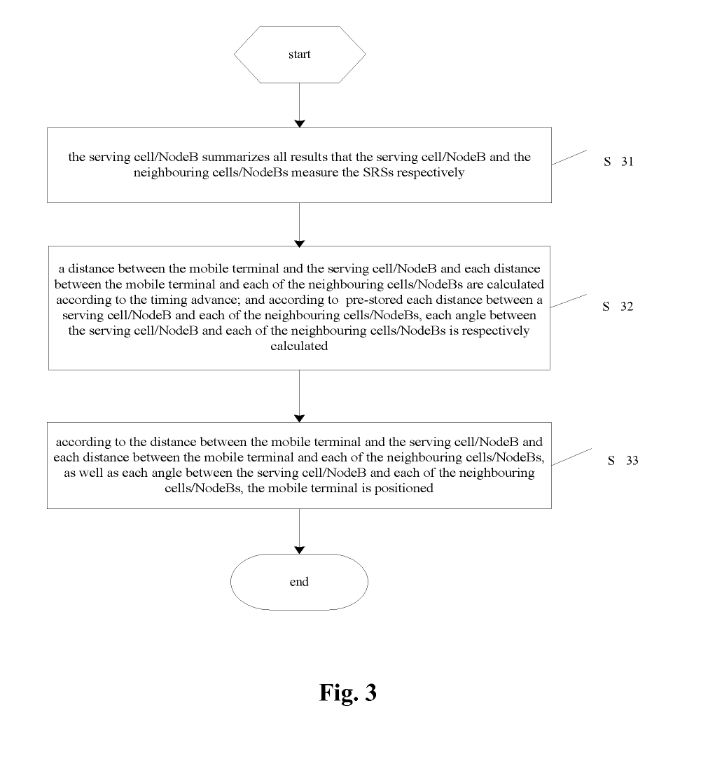

With reference to FIG. 3, FIG. 3 is a schematic flow chart for positioning a mobile terminal in a method for positioning a mobile terminal in an LTE system according to the embodiments of the disclosure.

In the above-mentioned embodiment, step S30 comprises:

step S31, the serving cell/NodeB summarizes all results that the serving cell/NodeB and the neighbouring cells/NodeBs measure the SRSs respectively;

step S32, a distance between the mobile terminal and the serving cell/NodeB and each distance between the mobile terminal and each of the neighbouring cells/NodeBs are calculated according to the timing advance; and according to pre-stored each distance between a serving cell/NodeB and each of the neighbouring cells/NodeBs, each angle between the serving cell/NodeB and each of the neighbouring cells/NodeBs is respectively calculated; and

step S33, according to the distance between the mobile terminal and the serving cell/NodeB and each distance between the mobile terminal and each of the neighbouring cells/NodeBs, as well as each angle between the serving cell/NodeB and each of the neighbouring cells/NodeBs, the mobile terminal is positioned.

When the serving cell/NodeB and neighbouring cells/NodeBs perform the SRS measurement, and after the neighbouring cells/NodeBs transfer the results of SRS measurement to the serving cells/NodeBs, the serving cell/NodeB summarizes all the results of SRS measurement each of which comprises the received signal strength indicator and the timing advance.

In the present embodiment, the number of neighbouring cells/NodeBs adjacent to the serving cell/NodeB is preferably 2, which are respectively defined as a first neighbouring cell/NodeB and a second neighbouring cell/NodeB. After the serving cell/NodeB receives the results of SRS measurement, the distance dₛ between the mobile terminal and the serving cell/NodeB, the distance d_{fCell} between the mobile terminal and the first neighbouring cell/NodeB and the distance d_{sCell} between the mobile terminal and the second neighbouring cell/NodeB are calculated according to the timing advance in the results of SRS measurement, i.e. calculating through the following formulas:

dₛ=Taₛ*V,

d_{fCell}=Ta_{fCell}*V,

d_{sCell}=Ta_{sCell}*V.

The V is a space propagation speed of an electromagnetic wave.

In this way, it may be determined that the mobile terminal is on a circular arc with the serving cell/NodeB being the centre and dₛ being the radius, and at the same time, it also may be determined that the mobile terminal is also on a circular arc with the first neighbouring cell/NodeB being the centre and d_{fCell} being the radius, as well as on a circular arc with the second neighbouring cell/NodeB being the centre and d_{sCell} being the radius.

Then, according to each pre-stored distance between a serving cell/NodeB and each of the neighbouring cells/NodeBs, an angle between the serving cell/NodeB and the first neighbouring cell/NodeB and an angle between the serving cell/NodeB and the second neighbouring cell/NodeB are respectively calculated. That is, according to the distance L_{s-f} between the serving cell/NodeB and the first neighbouring cell/NodeB and the distance Lₛ₋ₛ between the serving cell/NodeB and the second neighbouring cell/NodeB, the angle θₛ₋ₛ between the serving cell/NodeB and the first neighbouring cell/NodeB and the angle and θ_{s-f} between the serving cell/NodeB and the second neighbouring cell/NodeB are calculated, i.e. using the cosine law:

Cos θ_{s-f}=(L²_{s-f}+d²ₛ−d²_{fCell})/2L_{s-f}dₛ

Cos θₛ₋ₛ=(Lₛ₋ₛ²+dₛ²−d²_{sCell})/2Lₛ₋ₛdₛ

thus cosine values of two angles θₛ₋ₛ and θ_{s-f} may be obtained, and then respective angles may be calculated by using the arc-cosine function, i.e. the angle θₛ₋ₛ between the serving cell/NodeB and the first neighbouring cell/NodeB, as well as the angle θ_{s-f} between the serving cell/NodeB and the second neighbouring cell/NodeB.

After obtaining the distance between the mobile terminal and serving cell/NodeB and each distance between the mobile terminal and each of the neighbouring cells/NodeBs as well as each angle between the serving cell/NodeB and each of the neighbouring cell/NodeB, the serving cell/NodeB positions the mobile terminal according the above distances and angles, thereby acquiring location information about the mobile terminal, and this may exclude the possibility of mirror images.

The serving cell/NodeB summarizes the results that the serving cell/NodeB and neighbouring cells/NodeBs measure the SRSs respectively; the distance between the mobile terminal and the serving cell/NodeB and each distance between the mobile terminal and each of the neighbouring cells/NodeBs are calculated according to the timing advance; each angle between the serving cell/NodeB and each of the neighbouring cells/NodeBs is calculated; and then according to the distance between the mobile terminal and the serving cell/NodeB and each distance between the mobile terminal and each of the neighbouring cells/NodeBs, as well as each angle between the serving cell/NodeB and each of the neighbouring cells/NodeBs, the mobile terminal is positioned. Thus, the mobile terminal may be accurately positioned without adding any device, without coordination of the network side, and without any additional network device, and the mobile terminal does not need to meet any extra functional requirement.

The embodiments of the disclosure further provide a system for positioning a mobile terminal in an LTE system.

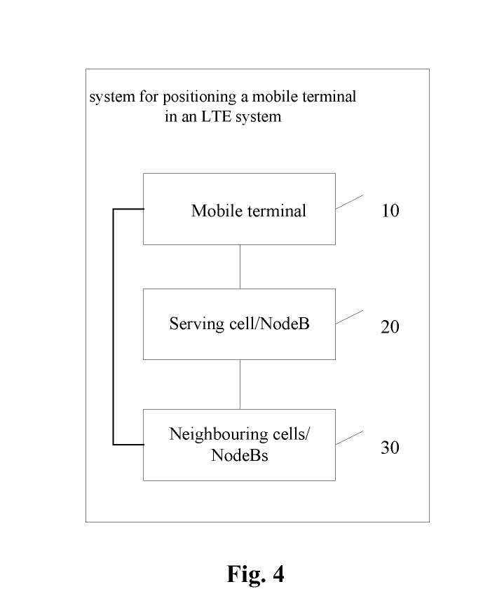

With reference to FIG. 4, FIG. 4 is a structural schematic diagram of a system for positioning a mobile terminal in an LTE system according to an embodiment of the disclosure.

The embodiment of the disclosure provides a system for positioning a mobile terminal in an LTE system. The system comprises a mobile terminal 10, a serving cell/NodeB 20 and neighbouring cells/NodeBs 30 adjacent to the serving cell/NodeB 20.

The serving cell/NodeB 20 is configured to send respectively resource reservation notification messages to multiple neighbouring cells/NodeBs adjacent to the serving cell/NodeB 20, to notify the neighbouring cells/NodeBs to reserve measurement resources for SRS measurement of a mobile terminal; to perform SRS measurement according to an SRS sent by the mobile terminal; and to position the mobile terminal according to results that the serving cell/NodeB and the multiple neighbouring cells/NodeB respectively measure the SRSs.

The mobile terminal 10 is configured to send the SRSs to the serving cell/NodeB and neighbouring cells/NodeBs through the measurement resources respectively; and

The neighbouring cells/NodeBs 30 is configured to perform the SRS measurement according to the SRSs sent by the mobile terminal

When the mobile terminal 10 is positioned, firstly a serving cell/NodeB 20 to which the mobile terminal 10 belongs is determined, and multiple neighbouring cells/NodeBs 30 adjacent to the serving cell/NodeB 20 are determined, and the resource reservation notification messages are sent to multiple neighbouring cells/NodeBs 30 through the serving cell/NodeB 20, wherein the resource reservation notification messages are used for notifying the neighbouring cells/NodeBs 30 to reserve measurement resources for the mobile terminal 10 to perform SRS measurement so that the neighbouring cells/NodeBs may receive the SRSs sent by the mobile terminal 10 on the reserved measurement resources respectively. While the serving cell/NodeB 20 sends the resource reservation notification messages to the multiple neighbouring cells/NodeBs 30, a sending notification message for notifying the mobile terminal 10 to send the SRS is sent to the mobile terminal 10.

After receiving the sending notification message sent by the serving cell/NodeB 20, the mobile terminal 10 begins to send the SRSs to the serving cell/NodeB 20 and neighbouring cells/NodeBs 30 respectively. After receiving the SRSs, the serving cell/NodeB 20 and neighbouring cells/NodeBs 30 perform SRS measurement according to the SRSs respectively; after the measurement ends, the neighbouring cells/NodeBs 30 will transfer the results of the SRS measurement to the serving cell/NodeB 20 respectively. In the present embodiment, the result of SRS measurement comprises a received signal strength indicator and a timing advance.

After the serving cell/NodeB 20 and neighbouring cells/NodeBs 30 respectively complete the SRS measurement, the serving cell/NodeB 20 positions the mobile terminal 10 according to the results of the SRS measurement after the measurement, i.e. according to the received signal strength indicator and the timing advance.

In the embodiment of the disclosure, the serving cell/NodeB sends resource reservation notification messages to notify the neighbouring cells/NodeBs to reserve measurement resources for SRS measurement of the mobile terminal, and meanwhile sends a sending notification message to the mobile terminal for notifying same to sending the SRSs; then the mobile terminal sends the SRSs to the serving cell/NodeB and neighbouring cells/NodeBs through measurement resources respectively, so that the serving cell/NodeB and the neighbouring cells/NodeBs perform SRS measurement respectively; and the serving cell/NodeB positions the mobile terminal according to the results of the SRS measurement. By means of the method, the mobile terminal may be accurately positioned without adding any device, without coordination of the network side, and without any additional network device, and the mobile terminal does not need to meet any extra functional requirement.

Based on the above-mentioned embodiment, the serving cell/NodeB 20 is further configured to:

judge whether there is pre-stored information about multiple neighbouring cells/NodeBs adjacent to the serving cell/NodeB; if not, then notify the mobile terminal to measure information about neighbouring cells/NodeBs adjacent to the serving cell/NodeB, or initiate a paging message to the mobile terminal so as to acquire information about the neighbouring cells/NodeBs.

When a serving cell/NodeB 20 to which the mobile terminal 10 belongs is determined, the serving cell/NodeB 20 judges whether there is pre-stored information about multiple neighbouring cells/NodeBs 30 adjacent to the serving cell/NodeB 20, wherein the pre-stored information comprises each distance between each of neighbouring cells/NodeBs 30 and the serving cell/NodeB 20 as well as signal strength of the neighbouring cells/NodeBs 30. If not, then the serving cell/NodeB 20 may notify the mobile terminal 10 to perform measurement of the neighbouring cells/NodeBs 30, i.e. by measuring each distance between the serving cell/NodeB 20 and each of the adjacent cells/NodeBs 30 adjacent to the serving cell/NodeB as well as the signal strength of the neighbouring cells/NodeBs 30, and generating a list of neighbouring cells/NodeBs 30 according to the strength of the signals obtained from the results of the measurement, and reporting the list to the serving cell/NodeB 20; the serving cell/NodeB 30 also may acquire information about the neighbouring cells/NodeBs 30 adjacent to the serving cell/NodeB by initiating a paging message to the mobile terminal 10, and the paging message initiated by the serving cell/NodeB 20 may be transmitted through a method, such as an uplink channel. After acquiring the information about the neighbouring cells/NodeBs 30, the serving cell/NodeB 20 stores same so as to select the neighbouring cells/NodeBs 30 according to each distance between the serving cell/NodeB and each of the neighbouring cells/NodeBs 30 as well as the signal strength of the neighbouring cells/NodeBs 30.

The serving cell/NodeB judges whether there is pre-stored information about multiple neighbouring cells/NodeBs adjacent to the serving cell/NodeB, and notifies the mobile terminal to measure information about neighbouring cells/NodeBs adjacent to the serving cell/NodeB, or initiates a paging message to the mobile terminal so as to acquire information about the neighbouring cells/NodeBs, and store information about the acquired neighbouring cells/NodeBs. The above solution may facilitate to position the mobile terminal according to information about the neighbouring cells/NodeBs.

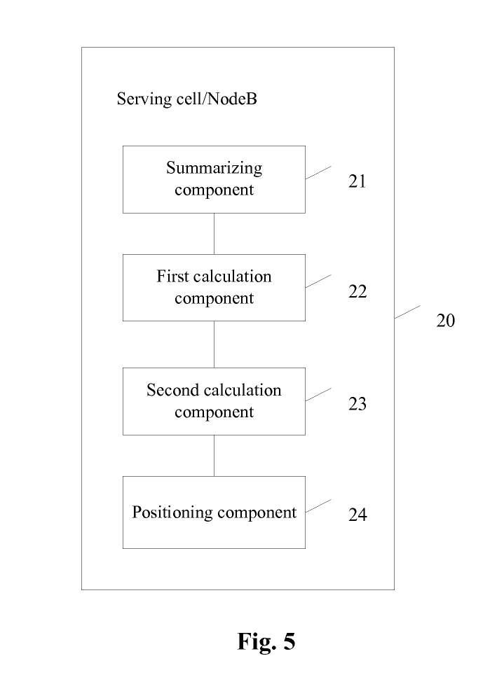

With reference to FIG. 5, FIG. 5 is a structural schematic diagram of a serving cell/NodeB in a system for positioning a mobile terminal in an LTE system according to an embodiment of the disclosure.

In the above-mentioned embodiment, the serving cell/NodeB 20 comprises:

a summarizing component 21 configured to summarize results that the serving cell/NodeB and neighbouring cells/NodeBs perform SRS measurement respectively;

a first calculation component 22 configured to acquire a distance between the mobile terminal and the serving cell/NodeB and each distance between the mobile terminal and each of the neighbouring cells/NodeBs according to the timing advance;

a second calculation component 23 configured to respectively calculate each angle between the serving cell/NodeB and each of the neighbouring cells/NodeBs according to each pre-stored distance between a serving cell/NodeB and each of the neighbouring cells/NodeBs; and

a positioning component 24 configured to position the mobile terminal according to the distance between the mobile terminal and the serving cell/NodeB and each distance between the mobile terminal and each of the neighbouring cells/NodeBs, as well as the angle between the serving cell/NodeB and each of the neighbouring cells/NodeBs.

When the serving cell/NodeB 20 and the neighbouring cells/NodeBs 30 perform the SRS measurement respectively, and after the neighbouring cells/NodeBs 30 transfer the results of SRS measurement to the serving cell/NodeB 20 respectively, the serving cell/NodeB 20 summarizes all the results of SRS measurement each of which comprises the received signal strength indicator and the timing advance through a summarization component 21 thereof.

In the present embodiment, the number of neighbouring cells/NodeBs adjacent to the serving cell/NodeB is preferably 2, which are respectively defined as a first neighbouring cell/NodeB and a second neighbouring cell/NodeB. After the serving cell/NodeB receives the result of SRS measurement, the distance dₛ between the mobile terminal and the serving cell/NodeB, the distance d_{fCell} between the mobile terminal and the first neighbouring cell/NodeB and the distance d_{sCell} between the mobile terminal and the second neighbouring cell/NodeB are calculated by the first calculation component 22 according to the timing advance in the result of the measurement, i.e. calculating through the following formulas:

dₛ=Taₛ*V,

d_{fCell}=Ta_{fCell}*V,

d_{sCell}=Ta_{sCell}*V.

The V is a space propagation speed of an electromagnetic wave.

In this way, it may be determined that the mobile terminal is on a circular arc with the serving cell/NodeB being the centre and dₛ being the radius, and at the same time, it also may be determined that the mobile terminal is also on a circular arc with the first neighbouring cell/NodeB being the centre and d_{fCell} being the radius, as well as on a circular arc with the second neighbouring cell/NodeB being the centre and d_{sCell} being the radius.

Then, according to a pre-stored distance between a serving cell/NodeB and each of the neighbouring cells/NodeBs, an angle between the serving cell/NodeB and the first neighbouring cell/NodeB and an angle between the serving cell/NodeB and the second neighbouring cell/NodeB are respectively calculated by the second calculation component 23. That is, according to the distance L_{s-f} between the serving cell/NodeB and the first neighbouring cell/NodeB, the angle θ_{s-f} between the serving cell/NodeB and the first neighbouring cell/NodeB is calculated, and the angle θₛ₋ₛ between the serving cell/NodeB and the second neighbouring cell/NodeB is calculated according to the distance Lₛ₋ₛ between the serving cell/NodeB and the second neighbouring cell/NodeB, i.e. using the cosine law:

Cos θ_{s-f}=(L²_{s-f}+d²ₛ−d²_{fCell})/2L_{s-f}dₛ

Cos θₛ₋ₛ=(Lₛ₋ₛ²+dₛ²−d²_{sCell})/2Lₛ₋ₛdₛ

thus cosine values of two angles θₛ₋ₛ and θ_{s-f} may be obtained, and then respective angle values may be calculated by using the arc-cosine function, i.e. the angle θₛ₋ₛ between the serving cell/NodeB and the first neighbouring cell/NodeB, as well as the angle θ_{s-f} between the serving cell/NodeB and the second neighbouring cell/NodeB.

After obtaining the distance between the mobile terminal and serving cell/NodeB 20, each distance between the mobile terminal and each of the neighbouring cells/NodeBs 30, and each angle between the serving cell/NodeB 20 and each of the neighbouring cell/NodeB 30, the serving cell/NodeB 20 positions the mobile terminal through the positioning component 24 according to the above distances and angles, thereby acquiring location information about the mobile terminal.

The serving cell/NodeB summarizes the results that the serving cell/NodeB and neighbouring cells/NodeBs perform the SRS measurement respectively; the distance between the mobile terminal and the serving cell/NodeB and each distance between the mobile terminal and each of the neighbouring cells/NodeBs are calculated according to the timing advance; each angle between the serving cell/NodeB and each of the neighbouring cells/NodeBs is calculated; and then according to the distance between the mobile terminal and the serving cell/NodeB and each distance between the mobile terminal and each of the neighbouring cells/NodeBs, as well as each angle between the serving cell/NodeB and each of the neighbouring cells/NodeBs, the mobile terminal is positioned. Thus, the mobile terminal may be accurately positioned without adding any device, without coordination of the network side, and without any additional network device, and the mobile terminal does not need to meet any extra functional requirement.

Any equivalent replacements of the structure or the flow based on the contents of the specification and drawings of the disclosure, or direct or indirect application of the equivalent replacements in other related technical fields shall fall within the scope of protection of the disclosure.

### INDUSTRIAL APPLICABILITY

As stated above, the method and system for positioning a mobile terminal in an LTE system which are provided in the embodiments of the disclosure have the following beneficial effects: a serving cell/NodeB respectively sends resource reservation notification messages to notify the neighbouring cells/NodeBs to reserve measurement resources for SRS measurement of a mobile terminal, and meanwhile sends a sending notification message to the mobile terminal for notifying the mobile terminal to send the SRSs; then the mobile terminal sends the SRSs to the serving cell/NodeB and neighbouring cells/NodeBs through measurement resources respectively, so that the serving cell/NodeB and the neighbouring cells/NodeBs perform SRS measurement respectively; and the serving cell/NodeB positions the mobile terminal according to results of the SRS measurement. In the embodiments of the disclosure, the mobile terminal may be accurately positioned without adding any device, without coordination of the network side, and without any additional network device, and the mobile terminal does not need to meet any extra functional requirement.

1. A method for positioning a mobile terminal in an LTE system, comprising:
a serving cell/NodeB respectively sending resource reservation notification messages to multiple neighbouring cells/NodeBs adjacent to the serving cell/NodeB, to notify the multiple neighbouring cells/NodeBs to reserve measurement resources which are for a mobile terminal to perform Sounding Reference Signal (SRS) measurement;
the mobile terminal respectively sending SRSs to the serving cell/NodeB and the multiple neighbouring cells/NodeBs by using the measurement resources to enable the serving cell/NodeB and the neighbouring cells/NodeBs to measure the SRSs; and
the serving cell/NodeB positioning the mobile terminal according to results that the serving cell/NodeB and the neighbouring cells/NodeBs respectively measure the SRSs.

2. The method according to claim 1, wherein each of the results that the serving cell/NodeB and the neighbouring cells/NodeBs measure the SRSs comprises a received signal strength indicator and a timing advance.

3. The method according to claim 1, wherein before the serving cell/NodeB respectively sends the resource reservation notification messages to the multiple neighbouring cells/NodeBs adjacent to the serving cell/NodeB, the method further comprises:
the serving cell/NodeB judging whether there is pre-stored information about the multiple neighbouring cells/NodeBs adjacent to the serving cell/NodeB; if there is not the pre-stored information about the multiple neighbouring cells/NodeBs adjacent to the serving cell/NodeB, then notifying the mobile terminal to measure information about the multiple neighbouring cells/NodeBs adjacent to the serving cell/NodeB, or initiating a paging message to the mobile terminal to acquire information about the multiple neighbouring cells/NodeBs.

4. The method according to claim 1, wherein the serving cell/NodeB positioning the mobile terminal according to the results that the serving cell/NodeB and the neighbouring cells/NodeBs respectively measure the SRSs comprises:
the serving cell/NodeB summarizing the results that the serving cell/NodeB and the multiple neighbouring cells/NodeBs respectively measure the SRSs;
calculating a distance between the mobile terminal and the serving cell/NodeB and each distance between the mobile terminal and each of the neighbouring cells/NodeBs through the timing advance; and according to each pre-stored distance between the serving cell/NodeB and each of the neighbouring cells/NodeBs, respectively calculating each angle between the serving cell/NodeB and each of the neighbouring cells/NodeBs; and
according to the distance between the mobile terminal and the serving cell/NodeB, each distance between the mobile terminal and each of neighbouring cells/NodeBs, and each angle between the serving cell/NodeB and each of the neighbouring cells/NodeBs, positioning the mobile terminal.

5. A system for positioning a mobile terminal in an LTE system, comprising a mobile terminal, a serving cell/NodeB and multiple neighbouring cells/NodeBs adjacent to the serving cell/NodeB, wherein
the serving cell/NodeB is configured to respectively send resource reservation notification messages to the multiple neighbouring cells/NodeBs adjacent to the serving cell/NodeB, to notify the multiple neighbouring cells/NodeBs to reserve measurement resources which are for a mobile terminal to perform Sounding Reference Signal (SRS) measurement; to measure an SRS according to the SRS sent by the mobile terminal; and to position the mobile terminal according to results that the serving cell/NodeB and the multiple neighbouring cells/NodeBs measure the SRSs;
the mobile terminal is configured to respectively send SRSs to the serving cell/NodeB and neighbouring cells/NodeBs through the measurement resources; and
the multiple neighbouring cells/NodeBs is configured to measure the SRSs according to the SRSs sent by the mobile terminal.

6. The system according to claim 5, wherein each of the results that the serving cell/NodeB and neighbouring cells/NodeBs measure the SRSs comprises a received signal strength indicator and a timing advance.

7. The system according to claim 5, wherein the serving cell/NodeB is further configured to:
judge whether there is pre-stored information about the multiple neighbouring cells/NodeBs adjacent to the serving cell/NodeB; if there is not pre-stored information about the multiple neighbouring cells/NodeBs adjacent to the serving cell/NodeB, then notify the mobile terminal to measure information about the multiple neighbouring cells/NodeBs adjacent to the serving cell/NodeB, or initiate a paging message to the mobile terminal so as to acquire information about the multiple neighbouring cells/NodeBs.

8. The system according to claim 5, wherein the serving cell/NodeB comprises:
a summarizing component configured to summarize the results that the serving cell/NodeB and the multiple neighbouring cells/NodeBs respectively measure the SRSs;
a first calculation component configured to acquire a distance between the mobile terminal and the serving cell/NodeB and each distance between the mobile terminal and the neighbouring cells/NodeBs through the timing advance;
a second calculation component configured to respectively calculate each angle between the serving cell/NodeB and each of the multiple neighbouring cells/NodeBs according to each pre-stored distance between the serving cell/NodeB and each of the multiple neighbouring cells/NodeBs; and
a positioning component configured to, according to the distance between the mobile terminal and the serving cell/NodeB, each distance between the mobile terminal and each of the multiple neighbouring cells/NodeBs, and each angle between the serving cell/NodeB and each of the neighbouring cells/NodeBs, position the mobile terminal.

9. The method according to claim 2, wherein the serving cell/NodeB positioning the mobile terminal according to the results that the serving cell/NodeB and the neighbouring cells/NodeBs respectively measure the SRSs comprises:
the serving cell/NodeB summarizing the results that the serving cell/NodeB and the multiple neighbouring cells/NodeBs respectively measure the SRSs;
calculating a distance between the mobile terminal and the serving cell/NodeB and each distance between the mobile terminal and each of the neighbouring cells/NodeBs through the timing advance; and according to each pre-stored distance between the serving cell/NodeB and each of the neighbouring cells/NodeBs, respectively calculating each angle between the serving cell/NodeB and each of the neighbouring cells/NodeBs; and
according to the distance between the mobile terminal and the serving cell/NodeB, each distance between the mobile terminal and each of neighbouring cells/NodeBs, and each angle between the serving cell/NodeB and each of the neighbouring cells/NodeBs, positioning the mobile terminal.

10. The method according to claim 3, wherein the serving cell/NodeB positioning the mobile terminal according to the results that the serving cell/NodeB and the neighbouring cells/NodeBs respectively measure the SRSs comprises:
the serving cell/NodeB summarizing the results that the serving cell/NodeB and the multiple neighbouring cells/NodeBs respectively measure the SRSs;
calculating a distance between the mobile terminal and the serving cell/NodeB and each distance between the mobile terminal and each of the neighbouring cells/NodeBs through the timing advance; and according to each pre-stored distance between the serving cell/NodeB and each of the neighbouring cells/NodeBs, respectively calculating each angle between the serving cell/NodeB and each of the neighbouring cells/NodeBs; and
according to the distance between the mobile terminal and the serving cell/NodeB, each distance between the mobile terminal and each of neighbouring cells/NodeBs, and each angle between the serving cell/NodeB and each of the neighbouring cells/NodeBs, positioning the mobile terminal.

11. The system according to claim 6, wherein the serving cell/NodeB comprises:
a summarizing component configured to summarize the results that the serving cell/NodeB and the multiple neighbouring cells/NodeBs respectively measure the SRSs;
a first calculation component configured to acquire a distance between the mobile terminal and the serving cell/NodeB and each distance between the mobile terminal and the neighbouring cells/NodeBs through the timing advance;
a second calculation component configured to respectively calculate each angle between the serving cell/NodeB and each of the multiple neighbouring cells/NodeBs according to each pre-stored distance between the serving cell/NodeB and each of the multiple neighbouring cells/NodeBs; and
a positioning component configured to, according to the distance between the mobile terminal and the serving cell/NodeB, each distance between the mobile terminal and each of the multiple neighbouring cells/NodeBs, and each angle between the serving cell/NodeB and each of the neighbouring cells/NodeBs, position the mobile terminal.

12. The system according to claim 7, wherein the serving cell/NodeB comprises:
a summarizing component configured to summarize the results that the serving cell/NodeB and the multiple neighbouring cells/NodeBs respectively measure the SRSs;
a first calculation component configured to acquire a distance between the mobile terminal and the serving cell/NodeB and each distance between the mobile terminal and the neighbouring cells/NodeBs through the timing advance;
a second calculation component configured to respectively calculate each angle between the serving cell/NodeB and each of the multiple neighbouring cells/NodeBs according to each pre-stored distance between the serving cell/NodeB and each of the multiple neighbouring cells/NodeBs; and
a positioning component configured to, according to the distance between the mobile terminal and the serving cell/NodeB, each distance between the mobile terminal and each of the multiple neighbouring cells/NodeBs, and each angle between the serving cell/NodeB and each of the neighbouring cells/NodeBs, position the mobile terminal.
